(19) United States
(12) Patent Application Publication
(10) Pub. No.: US 2022/0042810 A1
(43) Pub. Date: Feb. 10, 2022

(54) CONTROL METHOD, INFORMATION PROCESSING APPARATUS, AND SYSTEM

(71) Applicant: Toyota Jidosha Kabushiki Kaisha, Toyota-shi Aichi-ken (JP)

(72) Inventors: Tetsushi Okamoto, Nisshin-shi (JP); Kazumi Aono, Gamagori-shi (JP); Naoki Uenoyama, Nagoya-shi (JP); Equan Tompkins, Aubrey, TX (US)

(21) Appl. No.: 17/394,849

(22) Filed: Aug. 5, 2021

(30) Foreign Application Priority Data
Aug. 7, 2020 (JP) 2020-135350

(51) Int. Cl. G01C 21/34; G01C 21/36

(52) U.S. Cl. CPC G01C 21/3438; G01C 21/3492; G01C 21/3605

(57) ABSTRACT

A control method for an information processing apparatus includes acquiring information indicating a first facility set as a destination of a user, and information indicating a reference time associated with the first facility, acquiring information indicating an estimated arrival time at which the user is to arrive at the first facility, and notifying a proposal to change the destination based on the reference time and the estimated arrival time.

### CROSS-REFERENCE TO RELATED APPLICATION

This application claims priority to Japanese Patent Application No. 2020-135350, filed on Aug. 7, 2020, the entire contents of which are incorporated herein by reference.

### TECHNICAL FIELD

The present disclosure relates to a control method, an information processing apparatus, and a system.

### BACKGROUND

Technology for providing users with information is known. For example, Patent Literature (PTL) 1 discloses, with regard to provision of information, such as business hours, on where the availability of a service changes depending on the time of day, technology for providing the information taking into account a time when a user arrives.

### CITATION LIST

### Patent Literature

PTL 1: JP H10-160491 A

### SUMMARY

Improvement of technology for providing users with information is desired.

It would be helpful to improve technology for providing users with information.

A control method according to an embodiment of the present disclosure is a control method for an information processing apparatus, the control method including:

acquiring information indicating a first facility set as a destination of a user, and information indicating a reference time associated with the first facility;

acquiring information indicating an estimated arrival time at which the user is to arrive at the first facility; and

notifying a proposal to change the destination based on the reference time and the estimated arrival time.

An information processing apparatus according to an embodiment of the present disclosure is an information processing apparatus including a controller configured to:

acquire information indicating a first facility set as a destination of a user, and information indicating a reference time associated with the first facility;

acquire information indicating an estimated arrival time at which the user is to arrive at the first facility; and

notify a proposal to change the destination based on the reference time and the estimated arrival time.

A system according to an embodiment of the present disclosure is a system including a terminal apparatus and a server apparatus that are capable of communicating with each other, wherein the terminal apparatus or the server apparatus is configured to:

acquire information indicating a facility set as a destination of a user, and information indicating a reference time associated with the facility;

acquire information indicating an estimated arrival time at which the user is to arrive at the facility; and

notify a proposal to change the destination based on the reference time and the estimated arrival time.

According to an embodiment of the present disclosure, technology for providing users with information is improved.

### BRIEF DESCRIPTION OF THE DRAWINGS

In the accompanying drawings:

FIG. 1 is a block diagram illustrating a schematic configuration of a route guidance system according to an embodiment of the present disclosure;

FIG. 2 is a block diagram illustrating a schematic configuration of a terminal apparatus;

FIG. 3 is a block diagram illustrating a schematic configuration of a server apparatus;

FIG. 4 is a diagram illustrating an example of information stored in the server apparatus; and

FIG. 5 is a flowchart illustrating operations of the terminal apparatus and the server apparatus.

### DETAILED DESCRIPTION

Hereinafter, an embodiment of the present disclosure will be described.

### Summary of Embodiment

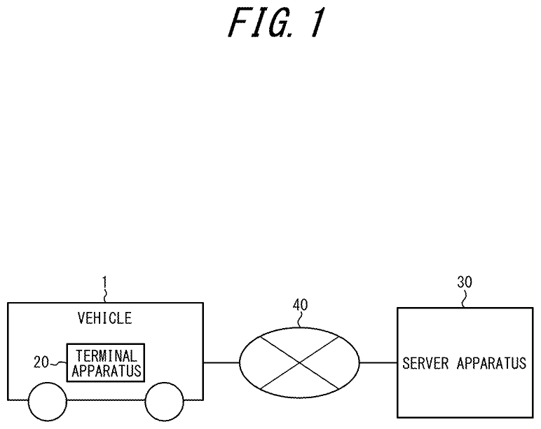

An outline of a route guidance system 1 according to an embodiment of the present disclosure will be described with reference to FIG. 1. The route guidance system 1 includes a vehicle 10, a terminal apparatus 20, and a server apparatus 30. The vehicle 10, the terminal apparatus 20, and the server apparatus 30 are communicably connected with a network 40 including, for example, a mobile communication network, the Internet, and the like.

The vehicle 10 is an automobile, for example, but not limited to this, and may be any vehicle that a person can board. The vehicle 10 may be capable of automated driving such as any one of Level 1 to Level 5 as defined by the Society of Automotive Engineers (SAE), for example. The terminal apparatus 20 is any information processing apparatus that a user can use. For example, an in-vehicle apparatus such as a navigation apparatus, or a general purpose apparatus such as a smartphone or a personal computer (PC) that is in the user's possession may be used as the terminal apparatus 20. The server apparatus 30 includes a single information processing apparatus or multiple information processing apparatuses that can communicate with each other. The server apparatus 30 has, for example, a route guidance function of notifying, via the terminal apparatus 20, the user of guidance information on a route.

First, an outline of the present embodiment will be described, and details thereof will be described later. For example, the server apparatus 30 acquires information indicating a facility set as a destination of the user, and information indicating a reference time associated with the facility. As will be described later, the reference time may be an opening time, a closing time, or a last order time for the facility set as the destination. The server apparatus 30 acquires information indicating an estimated arrival time at which the user is to arrive at the facility. Then, the server apparatus 30 notifies a proposal to change the destination based on the reference time and the estimated arrival time.

As described above, according to the present embodiment, a proposal to change the destination is notified based on a reference time and an estimated arrival time for the destination. For example, the occurrence of inconveniences such as the user missing a closing time or a last order time for the destination, or the user having to wait until an opening time after arriving at the destination may be reduced due to the proposal to change the destination. Therefore, technology for providing users with information is improved in that useful information that may reduce the occurrence of the inconveniences can be provided to the user.

Next, configurations of the route guidance system 1 will be described in detail.

(Configuration of Terminal Apparatus)

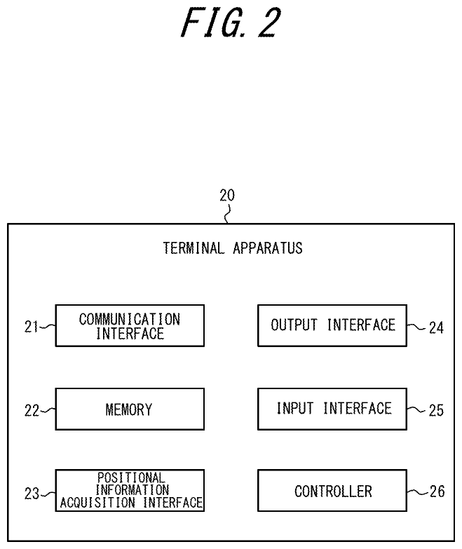

As illustrated in FIG. 2, the terminal apparatus 20 includes a communication interface 21, a memory 22, a positional information acquisition interface 23, an output interface 24, an input interface 25, and a controller 26.

The communication interface 21 may include at least one communication interface for connecting to the network 40. The communication interface is compliant with mobile communication standards such as the 4th generation (4G) standard and the 5th generation (5G) standard, for example, but not limited to these, and may be compliant with any communication standard. Alternatively, the communication interface 21 may include a communication interface to connect to the network 40 via an in-vehicle communication device mounted in the vehicle 10. The communication interface is communicably connected to the in-vehicle communication device via wired or wireless communications. In the present embodiment, the terminal apparatus 20 is connected to the network 40 via the communication interface 21.

The memory 22 includes one or more memories. In the present embodiment, the “memories” are semiconductor memories, magnetic memories, optical memories, or the like, for example, but are not limited to these. The memories included in the memory 22 may each function as, for example, a main memory, an auxiliary memory, or a cache memory. The memory 22 stores any information used for operations of the terminal apparatus 20. For example, the memory 22 may store a system program, an application program, embedded software, and the like. The information stored in the memory 22 may be updated with, for example, information acquired from the network 40 via the communication interface 21.

The positional information acquisition interface 23 may include at least one device for acquiring positional information for the terminal apparatus 20. Specifically, the positional information acquisition interface 23 is a receiver corresponding to the Global Positioning System (GPS), for example, but is not limited to this, and may be a receiver corresponding to any satellite positioning system. Alternatively, the positional information acquisition interface 23 may include an interface for acquiring positional information from a receiver mounted in the vehicle 10. In the present embodiment, the positional information for the terminal apparatus 20 acquired by the positional information acquisition interface 23 is used as positional information for the user.

The output interface 24 may include at least one output device for outputting information to notify the user of the information. The output device is a display for outputting information as video, a speaker for outputting information as audio, or the like, for example, but is not limited to these. Alternatively, the output interface 24 may include an output interface for outputting information via an output device mounted in the vehicle 10.

The input interface 25 includes at least one input device for detecting user input. The input device is a physical key, a capacitive key, a touch screen integrally provided with a display of the output interface 24, a microphone for accepting audio input, or the like, for example, but is not limited to these. Alternatively, the input interface 25 may include an input interface for detecting user input via an input device mounted in the vehicle 10.

The controller 26 includes at least one processor. The “processor” is a general purpose processor or a dedicated processor that is dedicated to a particular specific processing in the present embodiment, but is not limited to these. The controller 26 controls the operations of the entire terminal apparatus 20. Details of the operations of the terminal apparatus 20 controlled by the controller 26 will be described later.

(Configuration of Server)

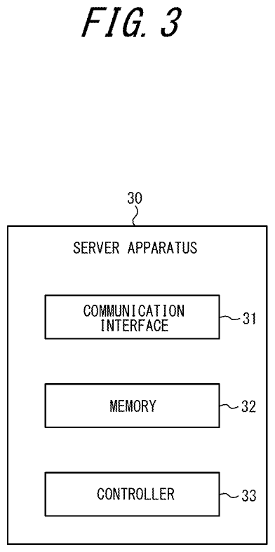

As illustrated in FIG. 3, the server apparatus 30 includes a communication interface 31, a memory 32, and a controller 33.

The communication interface 31 includes at least one communication interface for connecting to the network 40. The communication interface may be compliant with, for example, a wired local area network (LAN) standard or a wireless LAN standard. In the present embodiment, the server apparatus 30 is connected to the network 40 via the communication interface 31.

The memory 32 includes one or more memories. The memories included in the memory 32 may each function as, for example, a main memory, an auxiliary memory, or a cache memory. The memory 32 stores any information used for operations of the server apparatus 30. For example, the memory 32 may store a system program, an application program, a database, and the like. The information stored in the memory 32 may be updated with, for example, information acquired from the network 40 via the communication interface 31.

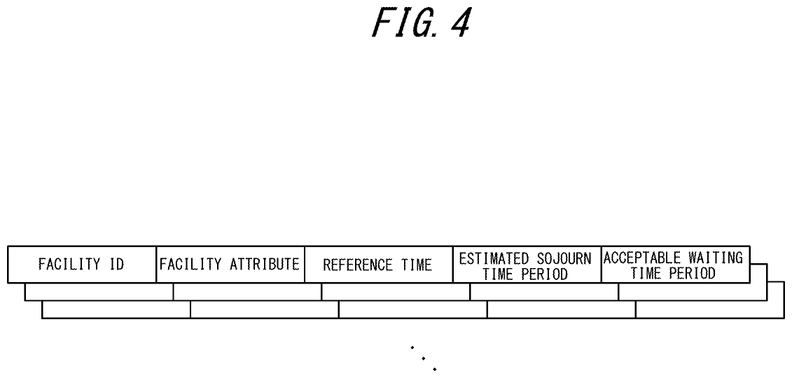

In the present embodiment, the memory 32 stores a facility database including a “facility ID”, a “facility attribute”, a “reference time”, an “estimated sojourn time period”, and an “acceptable waiting time period” for each facility, as illustrated in FIG. 4.

A “facility ID” is information uniquely identifying a facility. A “facility attribute” is information indicating an attribute of a facility. An attribute of a facility includes the type of the facility (“restaurant”, “department store”, “hospital”, or the like), but is not limited to this, and may include any information indicating the property of the facility such as a rating of the facility.

A “reference time” is information indicating a predetermined time associated with a facility. In the present embodiment, the “reference time” includes an opening time, a closing time, and/or a last order time for the facility, but is not limited to these. In the present embodiment, the controller 33 acquires the “reference time” from an external server via the network 40.

An “estimated sojourn time period” is information indicating an estimated value of a time period of sojourn by the user in a facility when the user visits the facility. Any method can be employed to determine the “estimated sojourn time period”.

For example, a value specified by the user, a statistic of sojourn time periods when the user visited the facility in the past, a statistic of sojourn time periods when a plurality of users visited the facility in the past, or the like may be employed as the “estimated sojourn time period”. As a sojourn time period when the user visited the facility, for example, a time period from an arrival time to a departure time at the facility when the user used the route guidance function of the server apparatus 30 can be employed. In the present embodiment, the controller 33 may determine the “estimated sojourn time period”, or the controller 33 may acquire the “estimated sojourn time period” from the external server via the network 40.

An “acceptable waiting time period” is information indicating an acceptable value of a waiting time period from arrival to entrance by the user into a facility when the user visits the facility. Any method can be employed to determine the “acceptable waiting time period”.

For example, a value specified by the user, a statistic of waiting time periods when the user visited the facility in the past, a statistic of waiting time periods when a plurality of users visited the facility in the past, or the like may be employed as the “acceptable waiting time period”. As a waiting time period when the user visited the facility, for example, a time period from an arrival time at the facility to an opening time for the facility when the user used the route guidance function of the server apparatus 30 can be employed. In the present embodiment, the controller 33 may determine the “acceptable waiting time period”, or the controller 33 may acquire the “acceptable waiting time period” from an external server via the network 40.

In the present embodiment, facility databases may be stored in the memory 32 for respective users, or a single facility database stored in the memory 32 may be shared by a plurality of users. The facility database may be distributed across multiple databases.

The controller 33 illustrated in FIG. 3 includes at least one processor. The controller 33 controls the operations of the entire server apparatus 30. Details of the operations of the server apparatus 30 controlled by the controller 33 will be described later.

(Flow of Operations of Route Guidance System)

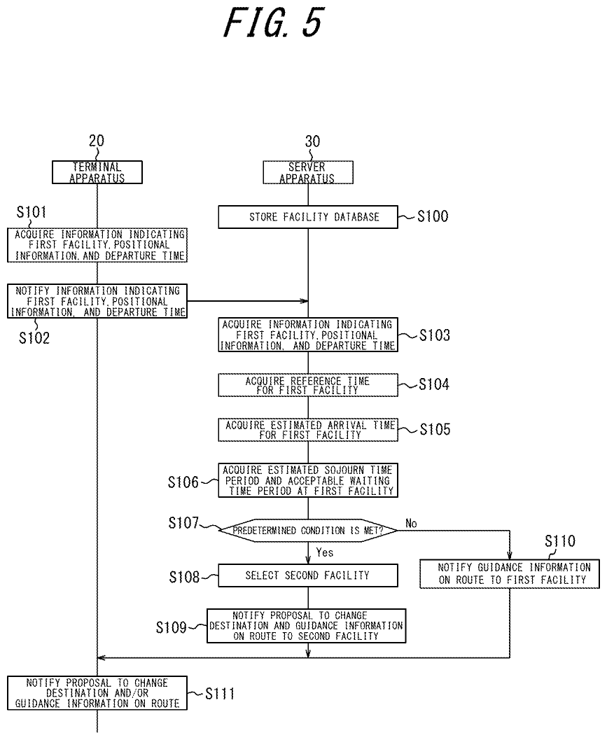

A flow of operations of the terminal apparatus 20 and the server apparatus 30 of the route guidance system 1 will be described with reference to FIG. 5. The flow of operations includes, for example, a flow of operations of notifying a user who uses the route guidance function of the server apparatus 30 of a proposal to change a destination.

Step S100: The controller 33 of the server apparatus 30 stores the facility database described above in the memory 32.

Step S101: The controller 26 of the terminal apparatus 20 acquires information indicating a first facility set as a destination of the user, positional information, and information indicating a departure time. The information indicating the first facility, for example, may be the name of the first facility input by the user or may be the facility ID of the first facility. The positional information, for example, may be acquired using the positional information acquisition interface 23 or may be specified by the user. The departure time, for example, may be the current time or may be specified by the user.

Step S102: The controller 26 notifies the server apparatus 30 of the information indicating the first facility, the positional information, and the information indicating the departure time.

Step S103: The controller 33 acquires, from the terminal apparatus 20, the information indicating the first facility, the positional information, and the information indicating the departure time.

Step S104: The controller 33 acquires information indicating the reference time associated with the first facility in the facility database. In the present embodiment, information indicating an opening time, a closing time, and/or a last order time for the first facility is acquired.

Step S105: The controller 33 acquires information indicating an estimated arrival time at which the user is to arrive at the first facility. In the present embodiment, the controller 33 acquires the estimated arrival time by calculating the estimated arrival time based on the information indicating the first facility, and the departure time that are acquired in step S103, road map information, and the like.

Step S106: The controller 33 acquires an estimated sojourn time period and/or an acceptable waiting time period of the user at the first facility. In the present embodiment, the estimated sojourn time period and the acceptable waiting time period that are associated with the first facility in the facility database are acquired as the estimated sojourn time period and the acceptable waiting time period of the user at the first facility.

Step S107: The controller 33 determines whether a predetermined condition for proposing a change of destination is met.

Specifically, the controller 33 may determine whether the predetermined condition is met based on the reference time and the estimated arrival time. In such a case, the predetermined condition may include a condition that a closing time or a last order time, which is the reference time, is earlier than the estimated arrival time.

Alternatively, the controller 33 may determine whether the predetermined condition is met based on the reference time, the estimated arrival time, and the estimated sojourn time period. In such a case, the predetermined condition may include a condition that a time period from the estimated arrival time to a closing time or a last order time, which is the reference time, is shorter than the estimated sojourn time period.

Alternatively, the controller 33 may determine whether the predetermined condition is met based on the reference time, the estimated arrival time, and the acceptable waiting time period. In such a case, the predetermined condition may include a condition that a time period from the estimated arrival time to an opening time, which is the reference time, is longer than the acceptable waiting time period.

In a case in which it is determined that the predetermined condition is met (S107—Yes), the process proceeds to step S108. In a case in which it is determined that the predetermined condition is not met (S107—No), the process proceeds to step S110.

Step S108: The controller 33 selects a second facility from among a plurality of facilities.

Specifically, in a case in which the reference time is a closing time or a last order time for the first facility, the controller 33 may select a facility whose closing time or last order time is later than the reference time as the second facility.

Alternatively, in a case in which the reference time is an opening time for the first facility, the controller 33 may select a facility whose opening time is earlier than the reference time as the second facility.

The controller 33 may select a facility whose facility attribute is the same or similar to the first facility as the second facility.

Step S109: The controller 33 notifies the terminal apparatus 20 of a proposal to change the destination from the first facility to the second facility and guidance information on a route to the second facility. Then, the process proceeds to step S111.

Step S110: The controller 33 notifies the terminal apparatus 20 of guidance information on a route to the first facility. Then, the process proceeds to step S111.

Step S111: The controller 26 of the terminal apparatus 20 notifies the user of the proposal to change the destination and/or guidance information on a route. Then, the process ends.

In detail, in a case in which the process has passed through step S109, the controller 26 notifies the user, via the output interface 24, of the proposal to change the destination from the first facility to the second facility and the guidance information on the route to the second facility.

Alternatively, in a case in which the process has passed through step S110, the controller 26 notifies the user, via the output interface 24, of the guidance information on the route to the first facility.

As described above, the route guidance system 1 according to the present embodiment acquires information indicating a facility set as a destination of a user, and information indicating a reference time associated with the facility, acquires information indicating an estimated arrival time at which the user is to arrive at the facility, and notifies a proposal to change the destination based on the reference time and the estimated arrival time.

According to such a configuration, a proposal to change the destination is notified based on a reference time and an estimated arrival time for the destination. For example, the occurrence of inconveniences such as the user missing a closing time or a last order time for the facility set as the destination, or the user having to wait until an opening time after arriving at the destination may be reduced due to the proposal to change the destination. Therefore, technology for providing users with information is improved in that useful information that may reduce the occurrence of the inconveniences can be provided to the user.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the terminal apparatus 20 executes some or all of the operations that are executed by the server apparatus 30 in the embodiment described above can be implemented.

For example, an embodiment in which a general purpose information processing apparatus functions as the terminal apparatus 20 or the server apparatus 30 according to the embodiment described above can also be implemented. Specifically, a program in which processes for realizing the functions of the terminal apparatus 20 or the server apparatus 30 according to the above-described embodiment are written may be stored in a memory of the information processing apparatus, and the program may be read and executed by a processor of the information processing apparatus. Accordingly, the present disclosure can also be implemented as a program executable by a processor, or a non-transitory computer readable medium storing the program.

1. A control method for an information processing apparatus, the control method comprising:
acquiring information indicating a first facility set as a destination of a user, and information indicating a reference time associated with the first facility;
acquiring information indicating an estimated arrival time at which the user is to arrive at the first facility; and
notifying a proposal to change the destination based on the reference time and the estimated arrival time.

2. The control method according to claim 1, wherein the reference time is a closing time or a last order time for the first facility.

3. The control method according to claim 2 further comprising acquiring an estimated sojourn time period for the user at the first facility,
wherein the notifying notifies the proposal based on the reference time, the estimated arrival time, and the estimated sojourn time period.

4. The control method according to claim 3, wherein the notifying notifies the proposal in a case in which a time period from the estimated arrival time to the reference time is shorter than the estimated sojourn time period.

5. The control method according to claim 4 further comprising selecting, from among a plurality of facilities, a second facility whose closing time or last order time is later than the reference time,
wherein the proposal includes a proposal to change the destination from the first facility to the second facility.

6. The control method according to claim 1, wherein the reference time is an opening time for the first facility.

7. The control method according to claim 6 further comprising acquiring an acceptable waiting time period for the user at the first facility,
wherein the notifying notifies the proposal based on the reference time, the estimated arrival time, and the acceptable waiting time period.

8. The control method according to claim 7, wherein the notifying notifies the proposal in a case in which a time period from the estimated arrival time to the reference time is longer than the acceptable waiting time period.

9. The control method according to claim 8 further comprising selecting, from among a plurality of facilities, a second facility whose opening time is earlier than the reference time,
wherein the proposal includes a proposal to change the destination from the first facility to the second facility.

10. An information processing apparatus comprising a controller configured to:
acquire information indicating a first facility set as a destination of a user, and information indicating a reference time associated with the first facility;
acquire information indicating an estimated arrival time at which the user is to arrive at the first facility; and
notify a proposal to change the destination based on the reference time and the estimated arrival time.

11. The information processing apparatus according to claim 10, wherein the reference time is a closing time or a last order time for the first facility.

12. The information processing apparatus according to claim 11, wherein the controller is configured to:
acquire an estimated sojourn time period for the user at the first facility; and
notify the proposal based on the reference time, the estimated arrival time, and the estimated sojourn time period.

13. The information processing apparatus according to claim 12, wherein the controller is configured to notify the proposal in a case in which a time period from the estimated arrival time to the reference time is shorter than the estimated sojourn time period.

14. The information processing apparatus according to claim 13, wherein
the controller is configured to select, from among a plurality of facilities, a second facility whose closing time or last order time is later than the reference time, and
the proposal includes a proposal to change the destination from the first facility to the second facility.

15. The information processing apparatus according to claim 10, wherein the reference time is an opening time for the first facility.

16. The information processing apparatus according to claim 15, wherein the controller is configured to:
acquire an acceptable waiting time period for the user at the first facility; and
notify the proposal based on the reference time, the estimated arrival time, and the acceptable waiting time period.

17. The information processing apparatus according to claim 16, wherein the controller is configured to notify the proposal in a case in which a time period from the estimated arrival time to the reference time is longer than the acceptable waiting time period.

18. The information processing apparatus according to claim 17, wherein
the controller is configured to select, from among a plurality of facilities, a second facility whose opening time is earlier than the reference time, and
the proposal includes a proposal to change the destination from the first facility to the second facility.

19. A system comprising a terminal apparatus and a server apparatus that are capable of communicating with each other, wherein the terminal apparatus or the server apparatus is configured to:
acquire information indicating a facility set as a destination of a user, and information indicating a reference time associated with the facility;
acquire information indicating an estimated arrival time at which the user is to arrive at the facility; and
notify a proposal to change the destination based on the reference time and the estimated arrival time.

20. The system according to claim 19, wherein the reference time is an opening time, a closing time, or a last order time for a facility corresponding to the facility.
